(19) United States
(12) Patent Application Publication
(10) Pub. No.: US 2002/0078066 A1
(43) Pub. Date: Jun. 20, 2002

(54) Data storage system including a file system for managing multiple volumes

(76) Inventors: David Robinson, Sunnyvale, CA (US); John H. Howard, Cambridge, MA (US); Randall D. Rettberg, Danville, CA (US)

Correspondence Address: B. Noel Kivlin, Conley, Rose & Tayon, P.C., P.O. Box 398, Austin, TX, 78767-0398, US

(21) Appl. No.: 09/740,540

(22) Filed: Dec. 18, 2000

(51) Int. Cl. G06F 7/00

(52) U.S. Cl. 707/104.1

(57) ABSTRACT

A data storage system including a file system for managing multiple volumes. The data storage system includes a first volume, a second volume and a computing node coupled to the first volume and the second volume. The computing node includes a file system for identifying files stored on the first volume and the second volume. The file system includes a directory structure having an entry corresponding to a file maintained by the file system. The entry includes a field containing a volume identifier indicative of which of the first or second volumes the file is stored within.

### BACKGROUND OF THE INVENTION

1. Field of the Invention

This invention is related to computer system data storage and, more particularly, to file systems used in data storage.

2. Description of the Related Art

In most cases, computer systems require data storage in one form or another. One type of computer system is a stand-alone system such as, for example, a single workstation running applications and storing data to files on a single disk drive or multiple disk drives that are directly connected to it. In such an environment, the workstation may use a local file system.

Frequently however, computer systems are deployed in a networked environment. In the networked environment, one or more client computer systems running user applications may be connected to one or more file servers which provide networked access to files used by the applications. Such a networked environment is referred to as a distributed file system.

Two important features of file systems are high reliability of the file system and efficient accessibility of the files. It is important that the file system be as immune as possible to any system failures (crashes, power failures, etc.). Additionally, it may be equally important that some files be accessed very quickly.

In some current file systems, if a user requires high reliability on some files and fast access on other files, a system administrator may need to allocate storage on different volumes to provide the different storage characteristics. The user may then have to keep track of where the different types of files are located within the network. For example, to obtain high reliability, a file may be stored within a volume corresponding to a data mirroring storage device. Alternatively, a volume corresponding to a data striping storage device may be used for storing a file requiring higher performance.

Many existing file systems create a single contiguous name space on a single disk or logical volume. This restricts all files within the contiguous name space to share the underlying volume's storage characteristics. Therefore, to store two files requiring two different storage characteristics, two different logical volumes may need to be created, each with the desired storage characteristics and thus different file systems or different contiguous name spaces. Each file requiring a corresponding storage characteristic will be stored on the logical volume containing that particular storage characteristic. However, a user must know which file system or contiguous name space contains the volume a particular file is stored within in order to access it.

FIG. 1 is a diagram of one embodiment of a typical directory structure. A directory structure 5 is shown including nodes A through N, where nodes A, B, C, D, F, G and J may be directories and nodes E, H, I, K, L, M and N may be files. Directory structure 5 is shown divided into volume 1, volume 2 and volume 3. As described above, many existing file systems may require that each file or directory has the same storage characteristics as its parent directory (i.e. the child directories may inherit the storage characteristics from their parent directories), or that a child directory be the root directory of a different volume than the parent directory. In FIG. 1, volume 1 includes directories A, B, D and G, and files H and I. Volume 2 includes directory J and files M and N, and volume 3 includes directories C and F, and files E, K and L. Each of these volumes may require a separate file system. In such embodiments, there may be software operating at a higher level of abstraction than the file systems and volumes. The software may keep track of directory links allowing a link between file systems, such as a link from directory G to directory J or a link from directory A to directory C. However, even when such links are supported, files and directories may still be required to have the same storage characteristics as their parent directories, if they are in the same file system and (by definition) on the same volume. Therefore, it is desirable to have more flexibility in a data storage system.

### SUMMARY OF THE INVENTION

Various embodiments of a data storage system including a file system for managing multiple volumes are disclosed. In one embodiment, the data storage system includes a first volume, a second volume and a computing node coupled to the first volume and the second volume. The computing node includes a file system for identifying files stored on the first volume and the second volume. The file system includes a directory structure having an entry corresponding to a file maintained by the file system. The entry includes a field containing a volume identifier indicative of which of the first or the second volumes the file is stored within.

In other embodiments, the file system may be configured to allocate space on the first volume and the second volume in response to receiving a request specifying a storage volume characteristic from a software application.

### BRIEF DESCRIPTION OF THE DRAWINGS

FIG. 1 is a diagram of a typical directory structure.

FIG. 2 is a block diagram of one embodiment of a computer system including a file system.

FIG. 3 is an exemplary diagram of one embodiment of the file system of FIG. 2.

FIG. 4A is a diagram of one embodiment of a directory structure.

FIG. 4B is a table of one embodiment of a grouping of the nodes of FIG. 4A.

FIG. 5 is a block diagram of a networked computing environment.

FIG. 6 is a block diagram illustrating one embodiment of a client, a metadata server and an object-based storage of FIG. 5.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

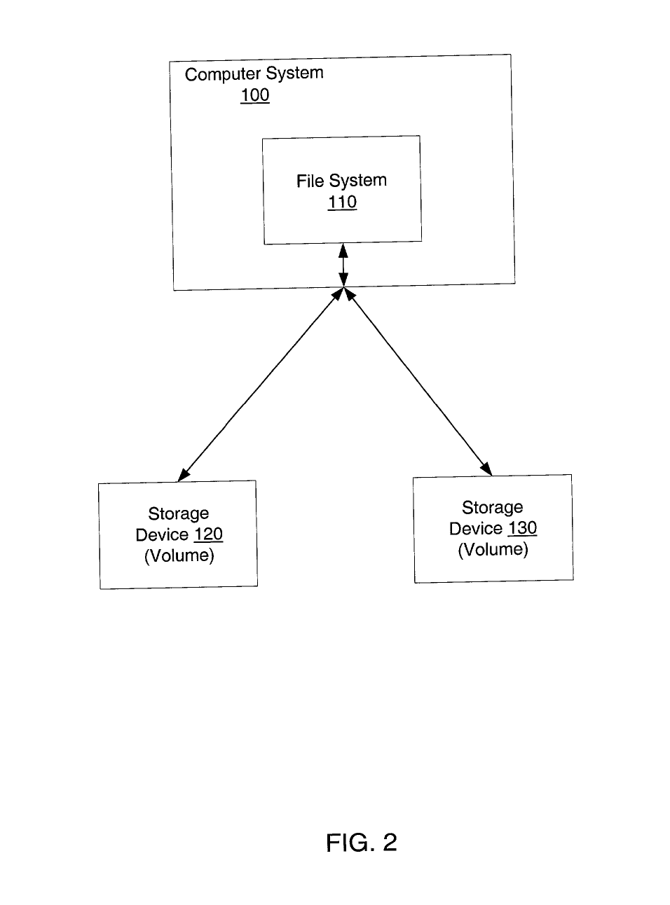

Turning now to FIG. 2, a block diagram of one embodiment of a computer system including a file system is shown. In the embodiment of FIG. 2, a computer system 100 is coupled to a storage device 120 and a storage device 130. Computer system 100 includes a file system 110. Storage device 120 and storage device 130 may be individual storage volumes.

In the illustrated embodiment, file system 110 may include a directory structure that is configured to maintain directories and files within those directories. Each of the files may be stored on either of storage device 120 or storage device 130 or both. As will be described in greater detail below, storage device 120 and storage device 130 may have different storage characteristics such as, for example, storage device 120 may be a Redundant Array of Inexpensive Disks (RAID) storage system and storage device 130 may be a single hard disk. Additionally, storage device 120 and storage device 130 may include any form of non-volatile computer readable medium such as, for example, one or more fixed or removable disk drives, tape drives, CD-ROMs, writeable CD-ROMs, etc. File system 110 may include entries for each file regardless of which storage device it is physically stored on.

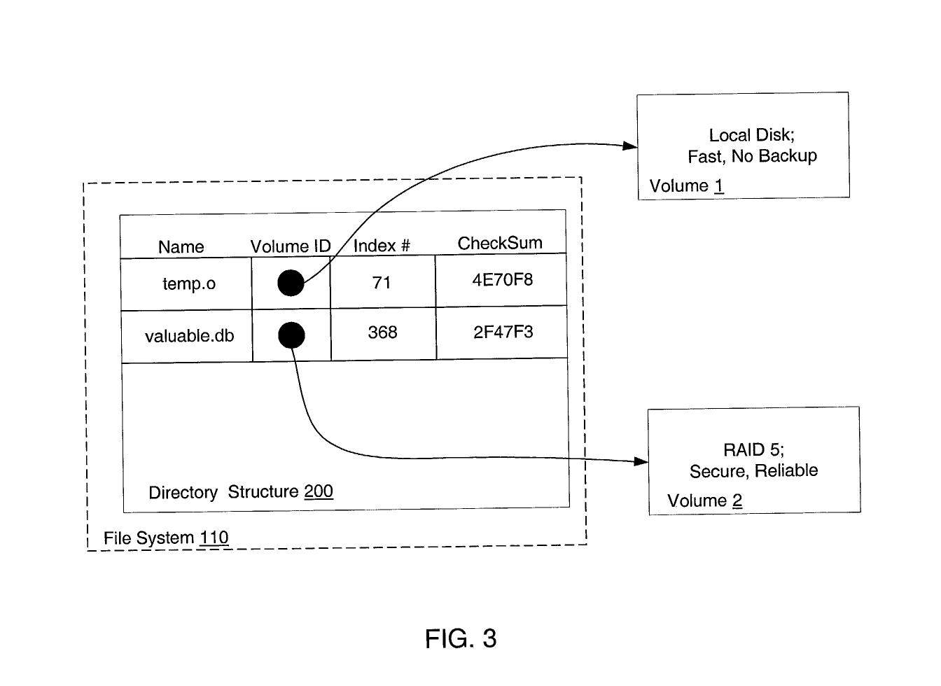

Referring to FIG. 3, aspects of one embodiment of the file system of FIG. 2 are shown. In the embodiment of FIG. 3, file system 110 includes a directory structure 200. Directory structure 200 is shown with two entries. Each entry in directory structure 200 may include several fields, such as name, volume identifier (ID), index number and checksum. The name field is the name of a particular file. In this example, the first entry contains a file with name ‘temp.o’. The volume ID field contains a volume identifier, which in the first entry is an identifier pointing to a single local disk where the file ‘temp.o’ is stored. The volume ID is a unique identifier of a logical volume that contains the file. In this embodiment, a logical volume may be a single storage entity or multiple storage entities, configured to appear like a single entity to the file system. The index number field contains an index number of the metadata corresponding to the file within a particular volume. In this example, the first index number is 71. In this embodiment, the checksum field contains the checksum value for the file. The logical volume may return the checksum value when the file is opened or closed. In the second entry, the filename is ‘valuable.db’. The index number is 237 and the volume ID points to a logical volume configured as a redundant array of inexpensive disks (RAID) 5 system. The index number 237 points to the metadata corresponding to that particular file on that particular logical volume. It is noted that in other embodiments, the checksum field may be omitted.

When an application creates a file within a directory, the application specifies to file system 110, which may be implemented as part of an operating system, the desired storage characteristics for that particular file. The storage characteristics may include information such as, for example, whether the data must be accessed very quickly or whether the data must be very reliable or the specific storage methods and structures for that volume. In a typical data storage system, there may be several different types of storage, such as for example, the RAID system mentioned above, a single disk storage or any other storage media available to store data. The operating system then allocates the required metadata and data blocks on a volume that matches the desired storage characteristics and stores the resulting volume ID and metadata index number in the corresponding fields of the entry in the directory structure.

Since each volume may be a different type of storage, each volume may have differing metadata, directory structure and data block allocation algorithms. Therefore, in order to allow a single file system, such as file system 110, to provide access to multiple volumes, each volume specifies a set of methods necessary to manipulate the metadata and directories, and to allocate data blocks. When file system 110 opens a file, a reference to the volume specific methods may be returned and may be used for subsequent accesses to the file. For example, a simple volume may allocate blocks with a first fit algorithm, while a more sophisticated volume may attempt to gather all the blocks related to one file within a contiguous range. In one embodiment, the methods and structures may be part of the volume and the file system may just invoke volume specific methods that relate to the particular volume associated with the file or directory's volume ID. This is in contrast to some existing file systems where the methods and structures may be a fundamental part of the file system.

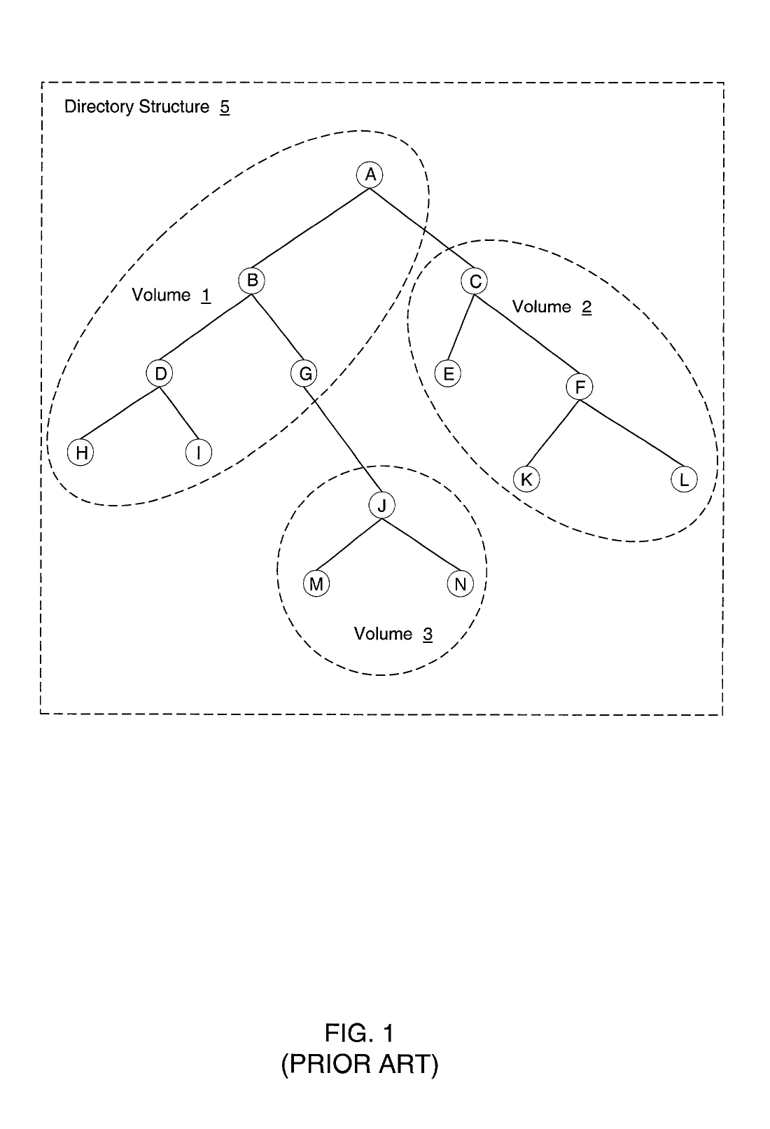

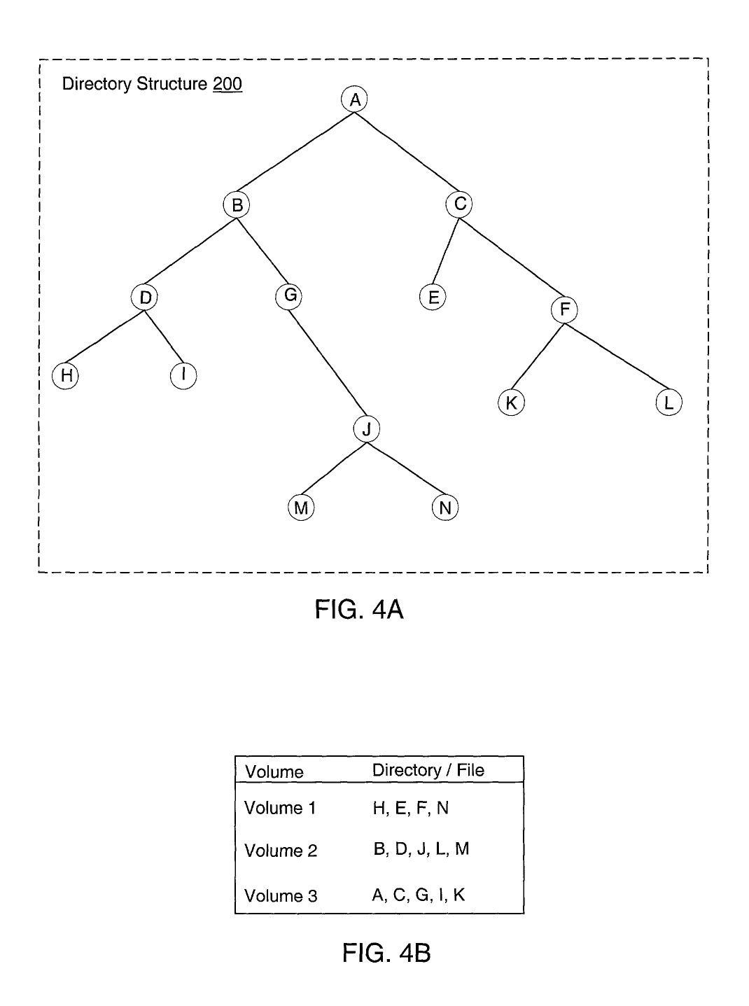

Referring to FIG. 4A, a diagram of one embodiment of a directory structure is shown. In the embodiment of FIG. 4, a directory structure 200 includes nodes labeled A through N. The nodes represent directories and files, where nodes A, B, C, D, F, G and J are directories and nodes E, H, I, K, L, M and N are files. In other words, the files and directories in directory structure 200 are similar to the directory structure in FIG. 1. However, as will be described further below, the way that each of the files may be accessed and stored in the storage volumes is different.

FIG. 4B is a table of one embodiment of a grouping of the nodes of FIG. 4A. The table includes volumes 1, 2 and 3, and the nodes in FIG. 4A may be grouped such that volume 1 may include nodes H, E, F and N. Volume 2 may include nodes B, L, M and J, and volume 3 may include nodes A, C, D, G, I and K. It is noted that this grouping is only one example of how they might be grouped. It is contemplated that many other groupings may be suitable. Each volume may be configured to provide different storage characteristics as described above in FIG. 3. Therefore, depending on the storage characteristics that a given file may have, a file system, such as file system 110 of FIG. 3 may allocate a particular file to be stored on a volume with the required storage characteristics. The files in a given directory may be allocated to different volumes based on the storage characteristics desired for each file, but the files may still logically reside in the same directory. Thus, file H of FIG. 4A, for example, may be stored in volume 1 and file I may be stored in volume 3, even though the parent directory D, which is common to both file H and file I, resides in volume 2.

Viewed in another way, the name space of directory structure 200 is separated from the allocation of files to volumes. Thus, directory structure 200 may be organized in a fashion which is logical to a user, and which allows the storage characteristics for each file to be obtained.

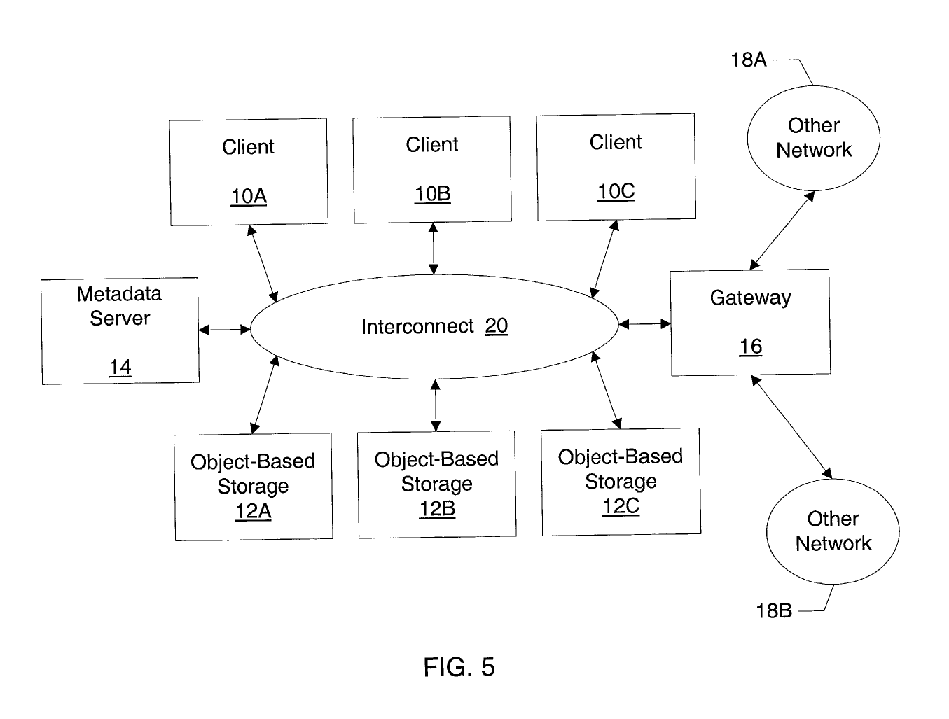

Turning now to FIG. 5, a block diagram of a networked computing environment is shown. In the embodiment of FIG. 5, the networked computing environment includes a plurality of clients 10A-10C, a plurality of object-based storages 12A-12C, a metadata server 14, a gateway 16, and other networks 18A-18B. Clients 10A-10C, storages 12A-12C, metadata server 14, and gateway 16 are connected via an interconnect 20. The metadata server 14 as depicted is configured to implement a file system (or portions of a file system) including a directory structure in accordance with the foregoing description of FIG. 3.

Generally, clients 10A-10C execute user applications that operate upon files stored on storages 12A-12C. A client 10A-10C may open a file by transmitting an open command to metadata server 14, which maps the file name used by the application to: (i) a file identifier (file ID) identifying the file to the storage 12A-12C storing the file; and (ii) a device identifier (device ID) identifying which storage 12A-12C stores the file. The metadata server 14 provides this information to the requesting client 10A-10C in response to the open command. The requesting client 10A-10C then performs various read and write commands directly to the storage 12A-12C identified by the device ID. Finally, the requesting client 10A-10C may perform a close command to the storage 12A-12C when the requesting client 10A-10C is finished accessing the file.

Object-based storage 12A-12C stores variable-sized objects instead of blocks. Each object is zero or more bytes, and a given object may be of an arbitrary length. For example, a file may be an object. Alternatively, a file may comprise two or more objects. The storage medium within object-based storage 12A-12C may still employ blocks, and in such an embodiment the object-based storage 12A-12C may perform the function of mapping files to blocks. As used herein, a block is a fixed-sized unit of storage space which is the smallest unit of allocation of space within the storage. Blocks may be of various sizes. For example, 4 kilobytes may be a suitable block size. Since the storage performs the block mapping function, access to the storage may be on an object basis (e.g. a file or a portion of a file) instead of a block basis. For example, a client 10A-10C may write one or more bytes to a file by transmitting a write command to the storage 12A-12C storing the file. The write command may include the file ID and the data to be written. The storage 12A-12C may handle merging the written bytes with the other data within the block. Previously, merging of writes into data blocks was performed by the client 10A-10C (by reading the affected block from the storage, updating the affected block locally in the client, and writing the affected block back to the storage). Similarly, a client 10A-10C may read one or more bytes from a file by transmitting a read command to the storage 12A-12C storing the file. The read command may include the file ID and the number of bytes to be read. Accordingly, the amount of data transmitted between the client and the storage may be reduced. Furthermore, client locking of blocks during updating may be eliminated.

Interconnect 20 may be a high bandwidth, low latency interconnect. For example, in one embodiment, interconnect 20 may be compatible with the Infiniband specification available from the Infiniband Trade Association. The Infiniband interconnect is based on switched serial links to device groups and devices. In other words, these devices or device groups may be connected with serial links either directly or through a switch. Devices on an InfiniBand network may be connected through switches and routers to several hosts. Each switch may operate a specific subnetwork of directly attached devices, while routers may interconnect several switches. InfiniBand devices may thus be connected in a fabric. Infiniband may use either packet or connection-based methods to communicate messages. Messages may include read or write operations, channel send or receive messages, atomic operations, or multicast operations. However, any interconnect having low latency may be used, including a variety of intranet or Internet interconnects such as Fibre Channel or Ethernet. For example, typical latencies from 1 to 100 microseconds may be provided by Infiniband.

Since clients directly access storage using a low latency interconnect, caching of file data on clients may be unnecessary. The low latency of the interconnect 20 may allow rapid access to file data, and the object-based nature of the storages 12A-12C may allow for relatively small amounts of data to be transferred for each request (e.g. less than a block). Accordingly, the complexities of client data caching may be eliminated.

Generally, each of clients 10A-10C and metadata server 14 may be a computing node. A computing node may comprise one or more computer systems operating in concert to perform a computing operation. A computer system may be a collection of: (i) one or more processors, interface circuitry, disk drives, network adapters, and other I/O devices; and (ii) an operating system and other applications which operate together to performing a designated computing function. Each computer system may be housed in a separate housing from other computer systems and may have a connection to interconnect 20.

Metadata server 14 stores file metadata. Among other things, the metadata stored by metadata server 14 may include the directory structures of the file systems within the networked computing environment shown in FIG. 1. The directory structures map a file name (which is a string of characters naming the file in a human-readable fashion) to a file ID (which is used to locate the file on the storage device, and may be a number having meaning only to the storage device storing the file). It is noted that there may be any number of metadata servers 14, as desired. Similarly, there may be any number of clients 10A-10C and storages 12A-12C, as desired.

Although the embodiment of FIG. 5 describes object-based storages 12A-12C, it is contemplated that storages 12A-12C may include any form of non-volatile computer readable medium. For example, storages 12A-12C may each include one or more fixed or removable disk drives, tape drives, CD-ROMs, writeable CD-ROMs, etc. Additionally, storages 12A-12C may include hardware and/or software for managing the mapping of file IDs to blocks within the storage, for object-based embodiments. In yet another alternative, storages 12A-12C may be block-based storages with software providing the object-based interface. The software may operate on the metadata server (or a combination of the metadata server and the storages), on the client (or a combination of the client and the storages), or on any combination of the metadata server, the client, and the storages.

Gateway 16 may be a computer system bridging from interconnect 20 to other networks 18A-18B. The other networks 18A-18B may be any form of network (e.g. the Internet, intranets, etc.). Additionally, one or more of the other networks may be networks interconnect by interconnect 20.

It is noted that clients 10A-10C, metadata server 14, object-based storages 12A-12C, and gateway 16 may each have independent connections to interconnect 20. Each of clients 10A-10C, metadata server 14, object-based storages 12A-12C, and gateway 16 may transmit messages to any other device connected to interconnect 20. Interconnect 20 may route the messages to the addressed device on interconnect 20.

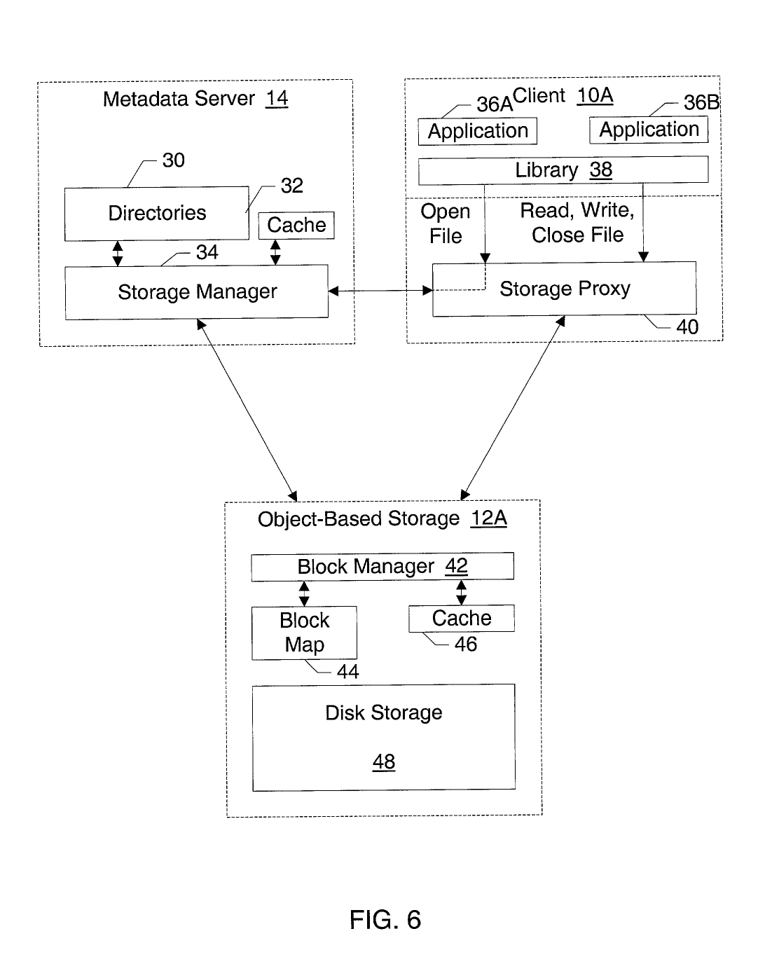

Turning now to FIG. 6, a block diagram illustrating one embodiment of metadata server 14, client 10A, and object-based storage 12A in greater detail is shown. In the illustrated embodiment, metadata server 14 includes a set of directories 30, a cache 32, and a storage manager 34. Client 10A includes one or more applications 36A-36B, a library 38, and a storage proxy 40. Object-based storage 12A includes a block manager 42, a block map 44, a cache 46, and a disk storage 48.

Generally, client 10A may execute applications 36A and 36B to perform various user-desired operations. The applications 36A-36B may use a variety of library routines which may be shared by the applications executable on client 10A. Among the library routines may be routines to open a file, read a file, write a file, and close a file. Applications may use these routines to access files. Applications 36A-36B and library 38 may operate at user privilege level, while storage proxy 40 may operate at a supervisor privilege level generally reserved for the operating system kernel. Storage proxy 40 may be part of the operating system kernel of client 10A. In other embodiments, both library 38 and storage proxy 40 may operate at the user privilege level, or at the supervisor privilege level, as desired.

In response to an application executing the open file routine, library 38 passes an open file command to the operating system kernel (e.g. to the storage proxy 40). The storage proxy 40 generates an open file command on the interconnect 20, addressed to metadata server 14. It is noted that storage proxy 40 may operate as a null driver in this case, simply passing the open file command as a message on interconnect 20 to metadata server 14.

Metadata server 14 (and more particularly storage manager 34) receives the open file command and consults the directories 30 to translate the file name to a file ID for one of storages 12A-12C. Storage manager 34 returns the file ID (and the device ID of the device storing the file, e.g. storage 12A) to storage proxy 40, which associates the file ID with the file name (or a file handle generated by library 38).

Subsequent read and write commands to the file are received from library 38 by storage proxy 40. The read and write commands include the file name or file handle. Storage proxy 40 generates corresponding read and write commands including the file ID corresponding to the file name or file handle, and transmit the read and write commands directly to storage 12A. As used herein, a command is directly transmitted from a client to a storage if the command is routed from the client to the storage without any intervening interpretation of the command other than to route the command to the destination storage. In other words, various circuitry included within interconnect 20 may interpret the address information used to route the command, but does not otherwise change the command. Similarly, a client may directly access a storage if commands are directly transmitted to the storage.

Storage 12A receives the read and write commands from client 10A. Block manager 42 may access a block map 44 to map the file ID to a set of one or more blocks within disk storage 48. The block affected by the command may thereby be identified, and the command may be performed. In the case of the write command, the block may be updated. In one embodiment described in more detail below, storage 12A may employ a copy on write protocol in which, rather than updating a block directly in response to a write command, a new block may be allocated and may be included in the block map for the file. When the file is closed or synchronized, the old block may be released for allocation to another file. Additional details for such an embodiment are provided further below. In the case of a read, the requested data may be read and provided back to the client 10A.

Generally speaking, the block map converts each file ID to a list of one or more blocks corresponding to the file. In one embodiment, the file ID is an inode number identifying an inode corresponding to the file. The inode includes pointers (directly or indirectly) to each block storing the file data. The inode may also include various file attributes, as desired.

It is noted that caches 32 and 46 may be used by storage manager 34 and block manager 42 (respectively) to accelerate operations. Caches 32 and 46 may be higher speed memories than the memory storing directories 30 and block map 44. For example, directories 30 and block map 44 may be stored on local disk storage of metadata server 14 and storage 12A, respectively. Caches 32 and 46 may be static random access memory (SRAM) or dynamic random access memory (DRAM), for example. Generally, caches 32 and 46 may be volatile memory while directories 30 and block map 44 maybe stored in non-volatile memory.

Storage manager 34 may use cache 32 to cache recently accessed directory entries. If the directory entries are accessed again, they may be read from the cache 32 instead of directories 30.

Block manager 42 may use cache 46 as a working memory for blocks and block map information (e.g. inodes and allocation maps). If a block is read from disk storage 48 (or is allocated for a write), the block may be stored in cache 46. If the block is read again, the block may be accessed in cache 46 and data provided to client 10A. If the block is allocated for a write, the block may be stored in cache 46 and written to disk storage 48 at a later time.

Storage manager 34 and storage proxy 40 may each preferably be one or more software routines included within the kernel of the operating system of metadata server 14 and client 10A, respectively. Block manager 42 may be implemented as one or more software routines executable by a processor embedded in storage 12A. However, any combination of hardware and/or software may be used to implement any of storage manager 34, storage proxy 40, and block manager 42.

It is noted that in some embodiments, a file may be represented by multiple objects on multiple object-based storage devices. In such a case, multiple file IDs may be used to locate the objects comprising the file. Furthermore, in some embodiments, object-based storage devices may be a combination of storage nodes (e.g. a RAID storage system, data striping storage systems, replicated storage systems, or concatenated storage systems). In such embodiments, the metadata server may provide the client with several device IDs in response to the open command, along with an indication of which device should be used for each read or write. In addition, since the volume ID described above is a logical volume identifier, it is also contemplated that in such embodiments, the file system may resolve the several device IDs into their respective volume IDs.

It is further noted that the file system 110 as described above may be employed in both standalone computer systems and within network computing environments.

Numerous variations and modifications will become apparent to those skilled in the art once the above disclosure is fully appreciated. It is intended that the following claims be interpreted to embrace all such variations and modifications.

What is claimed is:

1. A data storage system comprising:
a first volume;
a second volume; and
a computing node coupled to said first volume and said second volume, wherein said computing node includes a file system for identifying files stored by said first volume and said second volume;
wherein said file system includes a directory structure having an entry corresponding to a file maintained by said file system, and wherein said entry includes a field containing a volume identifier indicative of which of said first or said second volumes said file is stored within.

2. The system as recited in claim 1, wherein said file system is configured to allocate space on said first volume and said second volume in response to receiving a request specifying a storage volume characteristic from a software application.

3. The system as recited in claim 2, wherein each of said first volume and said second volume comprises a single storage device.

4. The system as recited in claim 2, wherein each of said first volume and said second volume comprises a multiple storage device system.

5. The system as recited in claim 4, wherein said multiple storage device system is a redundant array of inexpensive disks (RAID) storage system.

6. A file system for use in a computing node coupled to a first volume and a second volume, wherein said file system is configured to identify files stored by said first volume and said second volume, wherein said file system includes a directory structure having an entry corresponding to a file maintained by said file system, and wherein said entry includes a field containing a volume identifier indicative of which of said first or said second volumes said file is stored within.

7. The file system as recited in claim 6, wherein said file system is further configured to allocate space on said first volume and said second volume in response to receiving a request specifying a storage volume characteristic from a software application.

8. The file system as recited in claim 7, wherein each of said first volume and said second volume comprises a single storage device.

9. The file system as recited in claim 8, wherein each of said first volume and said second volume comprises a multiple storage device system.

10. The file system as recited in claim 9, wherein said multiple storage device system is a redundant array of inexpensive disks (RAID) storage system.

11. A method of operating a file system which identifies files stored by a first volume and a second volume, said method comprising:
providing a filename corresponding to a file maintained by said file system; and
accessing an entry in a directory structure, wherein said entry includes a field containing a volume identifier indicative of which of said first or said second volumes said file is stored within.

12. The method as recited in claim 11, wherein said method further comprises allocating space on said first volume and said second volume in response to receiving a request specifying a storage volume characteristic from a software application.

13. The method as recited in claim 12, wherein each of said first volume and said second volume comprises a single storage device.

14. The method as recited in claim 12, wherein said first volume and said second volume are each a logical volume, wherein said each logical volume comprises a multiple storage device system.

15. The method as recited in claim 14, wherein said multiple storage device system is a redundant array of inexpensive disks (RAID) storage system.

16. A computer readable medium comprising instructions for operating a file system which identifies files stored by a first volume and a second volume, wherein said instructions are executable by a computing node to implement a method comprising:
providing a filename corresponding to a file maintained by said file system; and
accessing an entry in a directory structure, wherein said entry includes a field containing a volume identifier indicative of which of said first or said second volumes said file is stored within.

17. The computer readable medium as recited in claim 16, wherein said method further comprises allocating space on said first volume and said second volume in response to receiving a request specifying a storage volume characteristic from a software application.

18. The computer readable medium as recited in claim 17, wherein each of said first volume and said second volume comprises a single storage device.

19. The computer readable medium as recited in claim 17, wherein each of said first volume and said second volume comprises a multiple storage device system.

20. The computer readable medium as recited in claim 19, wherein said multiple storage device system is a redundant array of inexpensive disks (RAID) storage system.

21. A data storage system comprising:
a first volume;
a second volume; and
a computing node coupled to said first volume and said second volume, wherein said computing node includes a file system for identifying a first file stored on said first volume and a second file stored on said second volume;
wherein said file system includes a directory structure having a directory which includes a first entry corresponding to said first file and a second entry corresponding to said second file.

22. The system as recited in claim 21, wherein said file system is configured to allocate space on said first volume and said second volume in response to receiving a request specifying a storage volume characteristic from a software application.

23. The system as recited in claim 22, wherein each of said first volume and said second volume comprises a single storage device.

24. The system as recited in claim 22, wherein each of said first volume and said second volume comprises a multiple storage device system.

25. The system as recited in claim 24, wherein said multiple storage device system is a redundant array of inexpensive disks (RAID) storage system.

26. A method comprising:
storing a first file on a first volume based on a first set of storage characteristics desired for said first file, wherein said first file is located in a directory of a directory structure maintained by a file system; and
storing a second file on a second volume based on a second set of storage characteristics desired for said second file, wherein said first file is located in said directory.

27. The method as recited in claim 26, wherein said method further comprises allocating space on said first volume and said second volume in response to receiving a request specifying a storage volume characteristic from a software application.

28. The method as recited in claim 27, wherein each of said first volume and said second volume comprises a single storage device.

29. The method as recited in claim 27, wherein said first volume and said second volume are each a logical volume, wherein said each logical volume comprises a multiple storage device system.

30. The method as recited in claim 29, wherein said multiple storage device system is a redundant array of inexpensive disks (RAID) storage system.

31. A computer memory containing a directory structure maintained by a file system having a first entry in a directory corresponding to a first file and a second entry in said directory corresponding to a second file, wherein said first file is stored on a first volume having a first set of storage characteristics and said second file is stored on a second volume having a second set of storage characteristics.

32. A computer memory containing a data structure for storing a directory having an entry corresponding to a file maintained by said file system, wherein said entry includes a field containing a volume identifier which indicates a volume said file is stored within.

33. A data storage system comprising:
one or more volumes;
a computing node coupled to said one or more volumes, wherein said computing node includes a file system for identifying files stored by said one or more volumes;
wherein said file system includes a directory structure having an entry corresponding to a file maintained by said file system, and wherein said entry includes a field containing a volume identifier indicative of which of said one or more volumes said file is stored within.
